(19) United States
(12) Patent Application Publication
(10) Pub. No.: US 2006/0077272 A1
(43) Pub. Date: Apr. 13, 2006

(54) Optical signal processor and image processing apparatus

(75) Inventors: Nobuyuki Yamada, Kyoto (JP); Yoshihiro Ikefuji, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: Rohm Co., Ltd.

(21) Appl. No.: 11/232,357

(22) Filed: Sep. 21, 2005

(30) Foreign Application Priority Data
Oct. 8, 2004 (JP) 2004-296848

(51) Int. Cl. H04N 5/335

(52) U.S. Cl. 348/308

(57) ABSTRACT

An optical signal processor capable of adding pixel-output voltages obtained from multiple photoelectric conversion elements. The optical signal processor is adapted to store the output signals sent from multiple photoelectric conversion elements in pixel-output voltage holding capacitors to generate the sum of the pixel-output voltages. At least two of the multiple pixel-output voltages are simultaneously coupled to the common signal line to add them up by an integration amplification circuit and output the added output voltage from the output end of the optical signal processor. Thus, the pixel-output voltages held by the multiple pixel-output holding circuits are mixed (or added) on the common signal line to a higher voltage before they are outputted as the output voltage.

### FIELD OF THE INVENTION

This invention relates to an image processing apparatus capable of adding up pixel outputs received from multiple photoelectric transducers, and to an image processing apparatus equipped with such optical signal processor.

### BACKGROUND OF THE INVENTION

FIG. 4 is a block diagram schematically illustrating a general structure of an image processing apparatus equipped with an optical signal processor and a controller therefor. As shown in FIG. 4, a group of photoelectric transducers (optical sensors) 100 arrayed in a predetermined region are television (raster) scanned using a vertical scanner 200 and a horizontal scanner 300. The output voltage Vo of the horizontal scanner 300 is provided as a standard television signal NTSC via a data processing circuit 400. Driving pulses for driving the vertical scanner 200 and the horizontal scanner 300 are supplied from a driver 500. The driver 500 is controlled by a controller 600.

It is often the case that in order to attain a faster reading speed than the normal speed the optical signal processor is used with its read resolution reduced to ½ or ⅓ of a standard resolution, rather than the normal read resolution in which every scanning line is read in sequence.

Reduction of the resolution to ½, for example from 600 dpi to 300 dpi can be easily carried out by simply extracting only those pixel outputs coming from odd numbered pixels rather than the entire pixels. However, photoelectric transducers used in an optical signal processor are mostly photo diodes or photo-transistors, whose read time is governed by data accumulation time. For example, readout with a double-faster speed requires reduction of data accumulation time by one half. Therefore, if the data is extracted with the read resolution reduced to one half as discussed above, then the output level will drop to about one half.

In order to solve this problem, a method of mixing signals on a common signal line (as disclosed in the specification of Japanese Patent No. 2915483, referred to as Document 1) can be used. In the method of Document 1, interlacing is performed for different lines belonging to respective fields, as shown in FIG. 5.

As seen in FIG. 5, pixel-output holding circuits 11-1N accumulate data received from photoelectric transducers 1-N and hold them in the form of pixel-output voltages V1-Vn.

Looking at a pixel-output holding circuit 11, a pixel-output voltage holding capacitor 111 is charged to a pixel-output voltage V1 by accumulating data received from a transducer 1 when the input switch 112 turns on. The pixel-output voltage V1 of the pixel-output voltage holding capacitor 111 is sent to a common signal line L1 when the output switch 113 turns on. The input switch 112 and output switch 113 are turned on and/or off by a control signal received from a pixel-output control logic 60. Other pixel-output holding circuits 12-1N are the same in structure as the pixel-output holding circuit 11. Like elements of these pixel-output holding circuits are indicated by like or corresponding reference symbols.

The voltage on the common signal line L1 is inputted into the input terminal of a voltage follower 51, which provides at the output end thereof an output voltage Vo. A floating capacitor 31 represents the floating capacitance Cs of the common signal line L1 and of the input circuit of the voltage follower 51.

Assuming that the pixel-output voltage supplied from the pixel-output holding circuit 11 of FIG. 5 is V1, the output voltage Vo will be given by the following formula.
Vo=V1×C1/(C1+Cs) (1)
where Cs is the capacitance of the floating capacitor 31, and C1 and C2 are respective capacitances of the data holding capacitors 111 and 121.

In mixing the pixel-output voltages V1 and V2 on the common signal lines L1, both of the switches 113 and 123 are simultaneously switched on. In this case, the output voltage Vo is given by the following formula.
Vo=V1×C1/(C1+Cs)+V2×C2/(C2+Cs) (2)
If V1=V2 and C1=C2 are assumed, the output voltage Vo becomes
Vo=V1×2·C1/(2·C1+Cs) (3)

The output voltage Vo given by formula (3) is larger than the output voltage Vo given by formula (1), we see that the signals are mixed on the common signal line L1. This mixing is called “addition” in Document 1.

For example, according to the method of Document 1, when C1=C2, Cs=3C1, and V1=V2, formula (1) gives Vo=0.25 V1 and formula (3) gives Vo=0.4 V1. That is, the output voltage Vo is not doubled if two identical pixel outputs are added up. Moreover, the resultant output voltage Vo cannot be larger than the pixel-output voltage V1 nor the voltage V2.

### SUMMARY OF THE INVENTION

It is, therefore, an object of the invention to provide an optical signal processor capable of adding up pixel-output voltages sent from multiple photoelectric transducers by storing the multiple pixel-output voltages in pixel output holding circuits and mixing them on a common signal line to generate an output voltage higher than the individual pixel-output voltages.

An inventive optical signal processor comprises:

a multiplicity of pixel-output holding circuits each including a pixel-output voltage holding capacitor for storing the signal outputted from an associated photoelectric transducer and for generating a pixel-output voltage;

a common signal line connectable to the respective output ends of the multiplicity of pixel-output holding circuits; and

an integration amplification circuit having an input end connected to the common signal line and an output end connected to the input end via an integration capacitor, the integration amplification circuit adapted to generate at the output end an output voltage.

This optical signal processor may be adapted to simultaneously connect the output ends of at least two of the multiplicity of pixel-output holding circuits to the common signal line so as to output the sum of the output voltages of the pixel-output holding circuits connected to the common signal line.

The integration amplification circuit may further include a differential amplifier having a first input terminal connected to the common signal line, a second input terminal receiving a reference voltage, and an output terminal, wherein the integration capacitor is connected between the first input terminal and the output terminal.

The integration amplification circuit may further include a first reset switch connected in parallel to the integration capacitor, and a second reset switch connected between the first and second input terminals, and wherein the first and second reset switches are switched on before the integration amplification circuit starts integration.

Each of the pixel-output holding circuit may further include:

an input switch connected between one end of the pixel-output voltage holding capacitor and the input end of the pixel-output holding circuit; and

an output switch connected between said one end of the pixel-output voltage holding capacitor and the output end of the pixel-output holding circuit.

The integration amplification circuit may further include a differential amplifier having a first input terminal connected to the common signal line, a second input terminal receiving a reference voltage, and an output terminal, wherein the integration capacitor is connected between the first input terminal and the output terminal. Each of the pixel-output holding circuit may further include an input switch connected between one end of the pixel-output voltage holding capacitor and the input end of the pixel-output holding circuit, and an output switch connected between said one end of the pixel-output voltage holding capacitor and the output end of the pixel-output holding circuit.

The other end of the pixel-output voltage holding capacitor may be connected to the second input terminal of the differential amplifier.

An inventive image processing apparatus comprises an optical signal processor according to the invention as described above, and a controller for controlling the optical signal processor.

According to the invention, pixel-output voltages obtained from multiple photoelectric transducers are held by associated pixel-output voltage holding capacitors, and then transferred onto a common signal line for addition thereof in current-transfer scheme. Thus, one may obtain a resultant output voltage of one pixel-voltage multiplied by the number of the pixels involved in the addition. It should be noted that the pixel-outputs held by pixel-output voltage holding capacitors are effectively utilized for addition, so that the resultant output voltage can be the sum of the respective pixel-outputs, which is much larger as compared with the conventional output voltage.

Unlike conventional addition performed in voltage transfer scheme, addition is properly performed in the present invention through current-transfer scheme to provide a desired resultant output voltage, without being much influenced by the magnitude of the floating capacitor of, for example, the common signal line.

Further, since the resultant output voltage is hardly influenced by the floating capacitor 31, the capacitance of each capacitor associated with the respective pixel can be minimized. Accordingly, the area of an IC occupied by the capacitors can be minimized.

Errors in the output voltage, caused by changes in the reference voltage for example, can be suppressed by connecting the other end of each pixel-output voltage holding capacitor to the second input terminal of the associated differential amplifier.

### BRIEF DESCRIPTION OF THE DRAWINGS

FIG. 1 is a schematic diagram showing the arrangement of an optical signal processor according to a first embodiment of the invention.

FIG. 2 is a timing diagram of the optical signal processor of FIG. 1.

FIG. 3 is a schematic diagram showing the arrangement of an optical signal processor according to a second embodiment of the invention.

FIG. 4 is a block diagram showing a general arrangement of an optical signal processor.

FIG. 5 shows an arrangement of a conventional optical signal processor

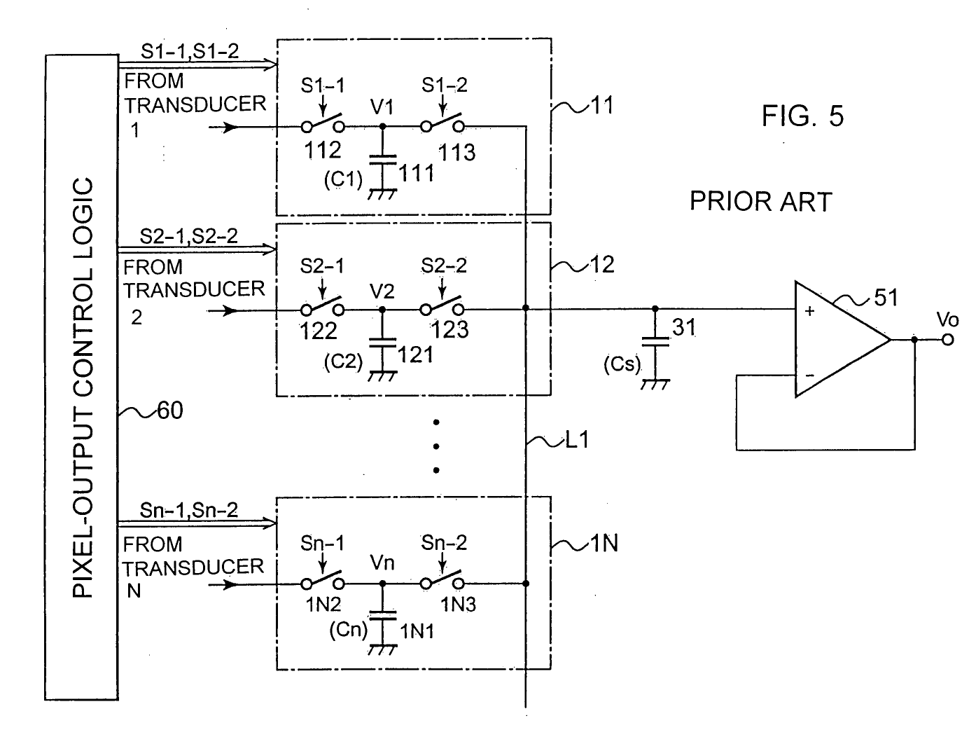

### DETAILED DESCRIPTION OF THE PREFERRED EMBODIMENT

An inventive optical signal processor will now be described in detail by way of example with reference to the accompanying drawings. The optical signal processor of the present invention may be applied to image processing apparatuses including solid-state imaging devices, photoelectric transducing apparatuses, image readers, facsimile machines, and digital copying machines.

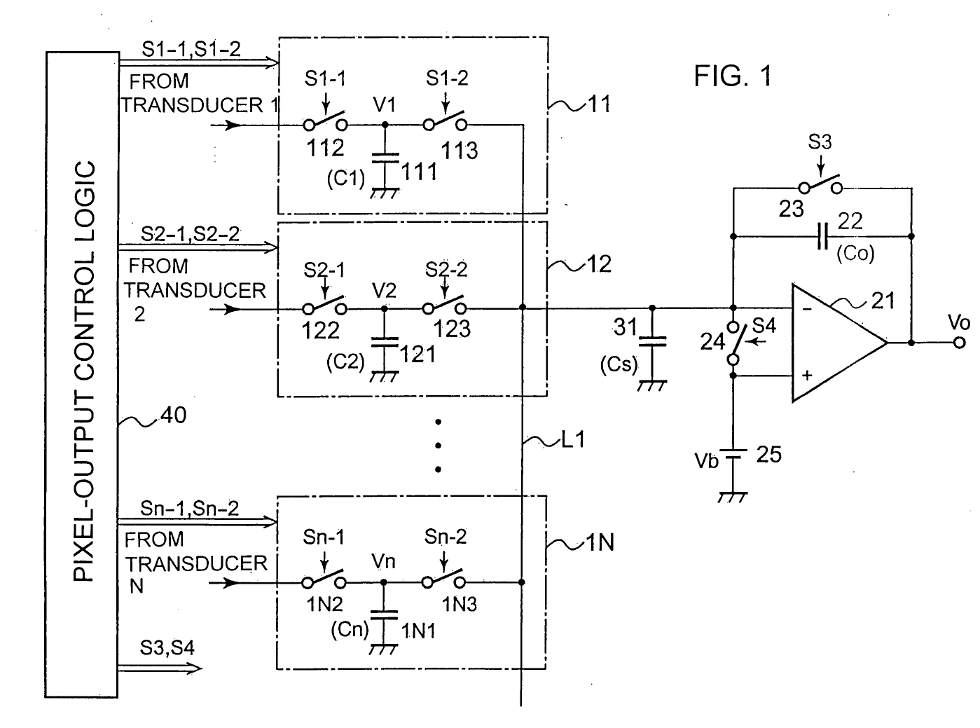

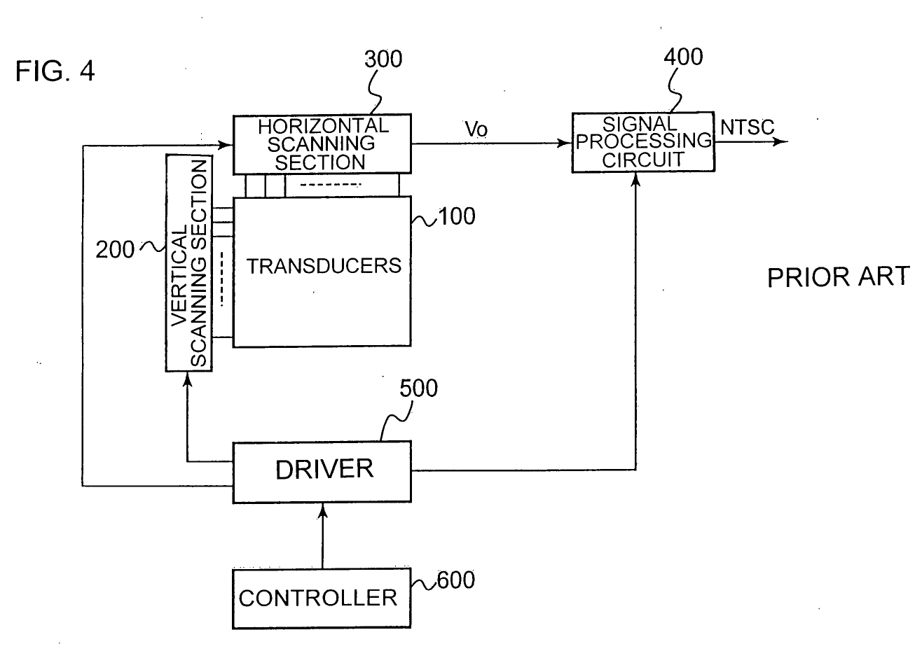

Referring to FIG. 1, there is shown an arrangement of an optical signal processor according to a first embodiment of the invention. The optical signal processor is installed in, for example, a horizontal scanner 300 as described in connection with FIG. 4.

As seen in FIG. 1, the optical signal processor is provided with a multiplicity of pixel-output holding circuits 11-1N each having an output end connected to a common signal line L1.

The pixel-output holding circuit 11 includes:

a pixel-output voltage holding capacitor 111 of the capacitance C1 for holding a signal outputted from a photoelectric transducer 1 to generate a pixel-output voltage V1;

an input switch 112 connected between one end of the pixel-output voltage holding capacitor 111 and the input end of the pixel output holding circuit 11; and

an output switch 113 connected between said one end of the pixel-output voltage holding capacitor 111 and the output end of the pixel-output holding circuit 11. The other end of the pixel-output voltage holding capacitor 111 is grounded. The input switch 112 is switched on and off by a control signal S1-1, and the output switch 113 is switched on and off by a control signal S1-2.

Other pixel-output holding circuits 12-1N are the same in structure as the pixel-output holding circuit 11. Like elements of these pixel-output holding circuits are indicated by like reference symbols.

The optical signal processor is provided with an integration amplification circuit, which includes:

a differential amplifier 21 having a first input terminal (−) connected to the common signal line L1, a second input terminal (+) receiving a reference voltage Vb from a reference voltage source 25, and an output terminal; and

an integration capacitor 22 having capacitance Co and connected between the first input terminal (−) and the output end of the differential amplifier 21. The reference voltage Vb may be zero volt, i.e. the second input terminal (+) may be grounded.

Connected in parallel to the integration capacitor 22 is a first reset switch 23. Connected between the input end (−) and the output end of the differential amplifier 21 is a second reset switch 24. The first and second reset switches 23 and 24, respectively, are respectively switched on and off by control signal S3 and S4.

A floating capacitor 31 represents the floating capacitance of the common signal line L1 and of the input circuit of the differential amplifier 21.

A pixel-output control logic 40 generates the control signals S1-1-Sn-2 to be supplied to the respective pixel-output holding circuits 11-1N. The pixel-output control logic 40 also generates control signals S3 and S4 to be supplied to the integration amplification circuit at appropriate timing.

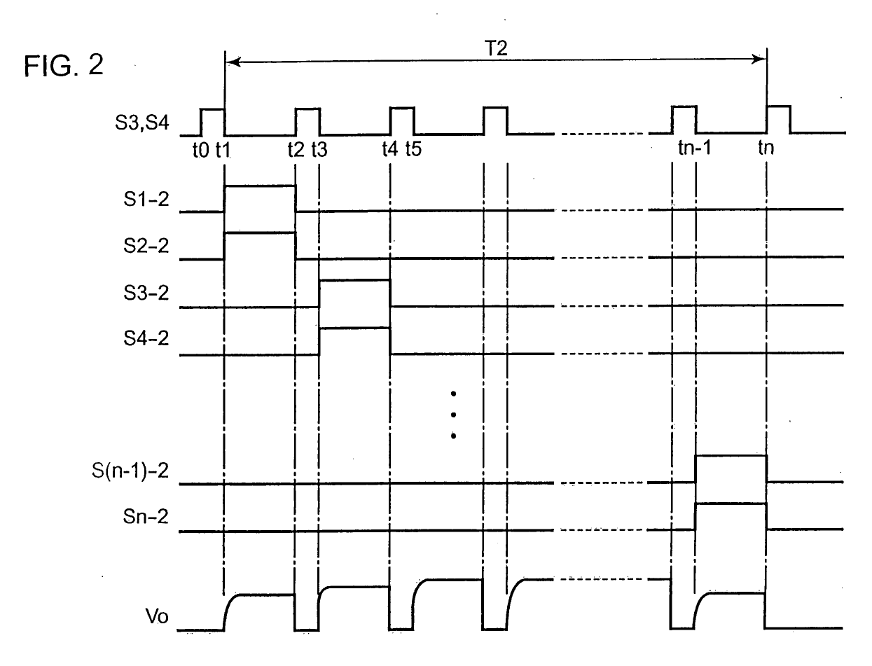

Referring to FIG. 2, there is shown a timing diagram for the optical signal processor of FIG. 1. This example shows a case where pixel-output voltages V1 and V2 are added. Of course, the invention is not limited to the addition of two pixel-output voltages, but may be applied to more than two pixel-output voltages. It will be apparent that the timing may be set so as to output only one pixel-output voltage.

The pixel-output voltage holding capacitors 111-1N1 are respectively charged by the outputs of photoelectric transducers 1-N while the respective input switches are 112-1N2 switched on. The charges accumulated in the respective pixel-output voltage holding capacitors 111-1N1 generates pixel-output voltages V1-Vn.

It is seen in FIG. 2 that the control signals S3 and S4 are pulled up to high (H) level for a short time interval t0-t1 to switch on the reset switches 23 and 24. As the reset switch 23 is switched on, the integration capacitor 22 is discharged to zero volt. When the reset switch 24 is switched on, the first and second input terminals of the differential amplifier 21 are short-circuited to initialize the common signal line L1 and the floating capacitor 31 to the reference voltage Vb.

In the example shown, the reset switches 23 and 24 are switched off at time t1. At the same time (time t1), the control signals S1-2 and S2-2 are pulled up to H level, causing both the output switch 113 of the pixel-output holding circuit 11 and the output switch 123 of the pixel-output holding circuit 12 to be switched on.

As a consequence, both the pixel-output voltage holding capacitors 111 and 121 are connected to the common signal lines L1. This in turn causes the integration amplification circuit to integrate or add up the outputs of the pixel-output voltage holding capacitors 111 and 121 during a time interval t1-t2 to provide a resultant output voltage Vo, i.e. the sum of the two pixel-output voltages.

The magnitude of the resultant output voltage Vo is given by the following formula.
Vo=(C1·ΔV1/Co)+(C2·ΔV2/Co) (4)
where
ΔV1=|V1−Vb| and ΔV2=|V2−Vb|.

If C1=C2 and ΔV1=V2, the output voltage Vo turns out to be
Vo=2·C1·ΔV1/Co (5)
Incidentally, when only one pixel-output voltage is sent to the common signal line L1, the output voltage Vo will be
Vo=C1·ΔV1/Co.
Thus, formula (5) shows that the output voltage Vo has a magnitude of one pixel-output voltage multiplied by the number of the pixels involved in the addition.

As a concrete numerical example comparing the resultant output voltage A for a single pixel-output voltage and the resultant output voltage B for two pixel-output voltages added according to the present invention with corresponding conventional resultant output voltages A and B, assume that C1=C2=1 pF, Cs=3 pF, and Co=1 pF.

The result is as follows.

| | A | B | B/A |
|---|---|---|---|
| Present invention: | Vo = ΔV1 | Vo = 2 · ΔV1 | 2.0 times |
| Conventional: | Vo = 0.25 · ΔV1 | Vo = 0.4 · ΔV1 | 1.6 times |

From this comparison, the difference between the two resultant output voltages Vo according to the present invention and conventional result will be clear. That is, the magnification factor of the invention for adding two pixel-outputs is 2, which is exceedingly larger than the corresponding conventional magnification factor. The magnitude of the output voltage Vo is also distinctly larger than that of conventional output voltage.

The control signals S3 and S4 are again pulled up to H level during a time interval t2-t3, when the reset switches 23 and 24 are switched on to initialize the signal line L1 and the floating capacitor 31 to the reference voltage Vb.

At time t3, the control signals S3-2 and S4-2 are pulled up to H level to add up the pixel-output voltages V3 and V4 sent from the respective pixel-output holding circuits 13 and 14 (not shown), outputting the sum of them as the resultant added output voltage Vo.

Similar addition procedure is repeated for every two subsequent pixel-output holding circuits in sequence, until the addition is performed for the pixel-output holding circuits 1N-1 and 1N at time tn.

If T1 is the period of cycle for reading all the pixel-voltages V1-Vn one at a time, then the period of cycle T2 (from t1 to tn) for reading all the pixel-voltages V1-Vn following the inventive scheme equals to T1/2.

Therefore, if the read resolution of the optical signal processor is reduced to one half of the standard resolution, the reading speed is doubled, so that data accumulation time to accumulate data from the photoelectric transducers is shortened to approximately one half of the standard data accumulation time, which enables doubling of the resultant output voltage Vo. Accordingly, a sufficient output voltage can be obtained if the resolution is reduced to one half.

It should be appreciated that the integration amplification circuit of the invention adds up pixel-outputs in a current transfer scheme, so that, unlike conventional addition using a voltage transfer scheme, the resultant output voltage is little affected by, for example, the floating capacitor 31 of the common signal line L1. Thus, an accurate output voltage Vo can be obtained without being influenced by the magnitude of the floating capacitor 31.

Since the resultant output voltage Vo of the addition is little affected by the floating capacitor 31, the capacitance of each capacitor associated with the respective pixel can be minimized. This in turn facilitates reduction of the dimensions of the IC on which the-capacitors are formed.

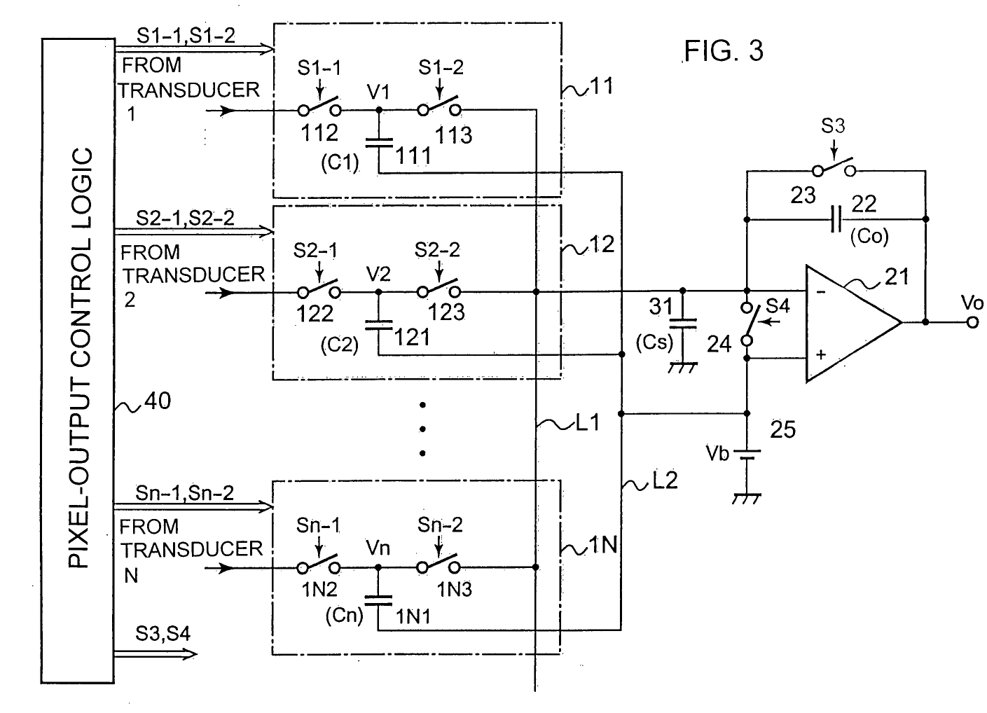

Referring to FIG. 3, there is shown an arrangement of an optical signal processor according to a second embodiment of the invention. In the example shown in FIG. 3, the other end of each pixel-output voltage holding capacitor 111 and 121, . . . , 1N1 is connected to the reference voltage source 25 via a common connection line L2 so that these ends are held at the reference voltage Vb. Other aspects of the arrangement are the same as in FIG. 1.

It is seen in the FIG. 3 that the voltage of the second input terminal (+) of the differential amplifier 21 is always equalized to the voltage of the other end of each pixel-output voltage holding capacitor 111 and 121, . . . , 1N1. As seen in FIG. 1, therefore, a change occurring in the reference voltage Vb or in the ground voltage for some reason could affect the output voltage Vo. In the arrangement of FIG. 3, however, the output voltage Vo will not be affected by such change if it occurs.

What we claim is:

1. An optical signal processor, comprising:
a multiplicity of pixel-output holding circuits each including a pixel-output voltage holding capacitor for storing the signal outputted from an associated photoelectric transducer and for generating a pixel-output voltage;
a common signal line connectable to the respective output ends of said multiplicity of pixel-output holding circuits; and
an integration amplification circuit having an input end connected to said common signal line and an output end connected to said input end via an integration capacitor, said integration amplification circuit adapted to generate at said output end an output voltage.

2. The optical signal processor according to claim 1, adapted to simultaneously connect the output ends of at least two of said multiplicity of pixel-output holding circuits to said common signal line so as to output the sum of the output voltages of said pixel-output holding circuits connected to said common signal line.

3. The optical signal processor according to claim 2, wherein:
said integration amplification circuit further includes a differential amplifier having a first input terminal connected to said common signal line, a second input terminal receiving a reference voltage, and an output terminal: and
said integration capacitor is connected between said first input terminal and said output terminal.

4. The optical signal processor according to claim 3, wherein said integration amplification circuit further includes:
a first reset switch connected in parallel to said integration capacitor; and
a second reset switch connected between said first and second input terminals, and wherein
said first and second reset switches are initially switched on before integration by said integration amplification circuit is started.

5. The optical signal processor according to claim 2, wherein each of said pixel-output holding circuit further includes:
an input switch connected between one end of said pixel-output voltage holding capacitor and the input end of said pixel-output holding circuit; and
an output switch connected between said one end of said pixel-output voltage holding capacitor and the output end of said pixel-output holding circuit.

6. The optical signal processor according to claim 2, wherein
said integration amplification circuit further includes a differential amplifier having a first input terminal connected to said common signal line, a second input terminal receiving a reference voltage, and an output terminal: and
said integration capacitor is connected between said first input terminal and said output terminal, and wherein
each of said pixel-output holding circuit further includes:
an input switch connected between one end of said pixel-output voltage holding capacitor and the input end of said pixel-output holding circuit; and
an output switch connected between said one end of said pixel-output voltage holding capacitor and the output end of said pixel-output holding circuit.

7. The optical signal processor according to claim 6, wherein
the other end of said pixel-output voltage holding capacitor is connected to said second input terminal of said differential amplifier.

8. An image processing apparatus, comprising:
an optical signal processor according to any one of claims 1-7; and
a controller for controlling said optical signal processor.
